(19) United States
(12) Patent Application Publication
(10) Pub. No.: US 2006/0230273 A1
(43) Pub. Date: Oct. 12, 2006

(54) Hidden MIRC printing for security

(75) Inventor: John F. Crichton, Honeoye Falls, NY (US)

Correspondence Address: Mark G. Bocchetti;Patent Legal Staff, Eastman Kodak Company, 343 State Street, Rochester, NY, 14650-2210, US

(73) Assignee: Eastman Kodak Company

(21) Appl. No.: 11/102,349

(22) Filed: Apr. 8, 2005

(51) Int. Cl. H04L 9/00

(52) U.S. Cl. 713/176

(57) ABSTRACT

A printing method, comprising marking an area of a receiver with a first marking material and marking in at least a portion of the area a security image with a second marking material, wherein the first and second marking material are configured such that the security image is unreadable by human vision and readable by a method other than human vision.

### BACKGROUND OF THE INVENTION

The invention relates to printing of documents with security features.

Fraud associated with certain documents, for example bank checks, is an old and well known problem. Problems include alteration, counterfeiting, and copying (which may be included as a subset of counterfeiting). Various measures and associated technologies have been developed to protect against fraud. Examples include intricate designs, microprinting, colorshifting inks, fluorescent inks, watermarks, fluorescent threads, colored threads, holograms, foil printing, and others.

Efforts regarding such systems have led to continuing developments to improve their versatility, practicality and efficiency.

### BRIEF DESCRIPTION OF THE DRAWINGS

FIGS. 1 and 2 present schematic diagrams of an electrographic marking or reproduction system in accordance with the present invention;

FIG. 3 presents an example of a development station implemented in the electrographic marking or reproduction system of FIGS. 1 and 2;

FIG. 4 presents a hiding strip in accordance with the invention; and

FIG. 5 presents a hiding strip in outline showing hidden printed MICR material in accordance with the present invention.

### DETAILED DESCRIPTION

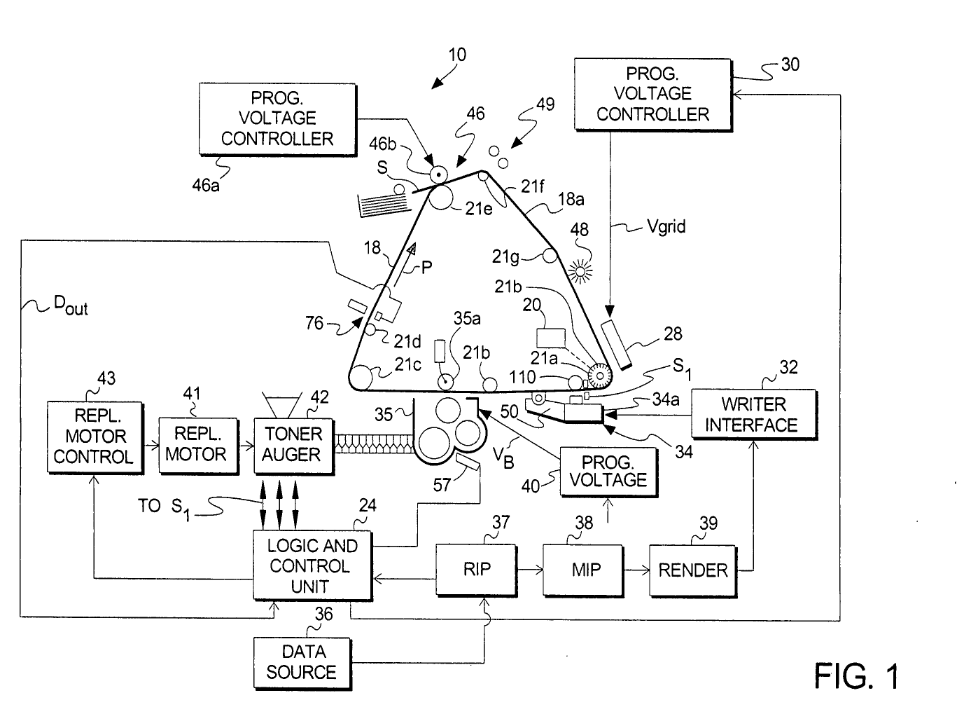

Referring to FIG. 1, a printer machine 10 includes a moving exposure medium 18, such as a photoconductive belt which is entrained about a plurality of rollers or other supports 21a through 21g, one or more of which is driven by a motor to advance the belt. By way of example, roller 21a is illustrated as being driven by motor 20. Motor 20 preferably advances the belt at a high speed, such as 20 inches per second or higher, in the direction indicated by arrow P, past a series of workstations of the printer machine 10. Alternatively, exposure medium 18 may be wrapped and secured about only a single drum.

Printer machine 10 includes a controller or logic and control unit (LCU) 24, preferably a digital computer or Microprocessor operating according to a stored program for sequentially actuating the workstations within printer machine 10, effecting overall control of printer machine 10 and its various subsystems. LCU 24 also is programmed to provide closed-loop control of printer machine 10 in response to signals from various sensors and encoders. Aspects of process control are described in U.S. Pat. No. 6,121,986 incorporated herein by this reference.

A primary charging station 28 in printer machine 10 sensitizes exposure medium 18 by applying a uniform electrostatic corona charge, from high-voltage charging wires at a predetermined primary voltage, to a surface 18a of exposure medium 18. The output of charging station 28 is regulated by a programmable voltage controller 30, which is in turn controlled by LCU 24 to adjust this primary voltage, for example by controlling the electrical potential of a grid and thus controlling movement of the corona charge. Other forms of chargers, including brush or roller chargers, may also be used.

An exposure station 34 in printer machine 10 projects light from a writer 34a to exposure medium 18. This light selectively dissipates the electrostatic charge on photoconductive exposure medium 18 to form a latent electrostatic image of the document to be copied or printed. Writer 34a is preferably constructed as an array of light emitting diodes (LEDs), or alternatively as another light source such as a Laser or spatial light modulator controlled by a writer interface controller 32. Writer 34a exposes individual picture elements (pixels) on exposure medium 18 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

Image data to be printed is provided by an image data source 36, which is a device that can provide digital data defining a version of the image. Such types of devices are numerous and include computer or microcontroller, computer workstation, scanner, digital camera, etc. These data represent the location and intensity of each pixel that is exposed by the printer. Signals from data source 36, in combination with control signals from LCU 24 are provided to a raster image processor (RIP) 37. The digital images (including styled text) are converted by the RIP 37 from their form in a page description language (PDL) and converted into a raster, which is a sequence of serial instructions in a form for the marking engine can accept (a process commonly known as “ripping”) and which provides the ripped image to an image storage and retrieval system known as a page buffer memory (PBM) 38.

The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the RIP. Once the images are in PBM, they can be repeatedly read from memory. The amount of memory required to store a given number of images can be reduced by compressing the images; therefore, the images are compressed prior to PBM memory storage, then decompressed while being read from PBM memory.

The output of the PBM is provided to an image render circuit 39, which alters the image and provides the altered image to the writer interface controller 32 which applies exposure parameters to the array writer (otherwise known as a write head, print head, etc.) to expose moving exposure medium 18.

After exposure, the portion of exposure medium 18 bearing the latent charge images travels to a development station 35. Development station 35 includes a magnetic brush in juxtaposition to the exposure medium 18. Magnetic brush development stations are well known in the art. Alternatively, other known types of development stations or devices may be used. Plural development stations 35 may be provided for developing images in plural grey scales, colors, or from toners of different physical characteristics. Full process color electrographic printing is accomplished by utilizing this process for each of four or more toner colors (e.g., black, cyan, magenta, yellow, etc.).

Upon the imaged portion of exposure medium 18 reaching development station 35, LCU 24 selectively activates development station 35 to apply toner to exposure medium 18 by moving backup roller 35a to move exposure medium 18, into engagement with or close proximity to the magnetic brush. Alternatively, the magnetic brush may be moved toward exposure medium 18 to selectively engage exposure medium 18. In either case, charged toner particles on the magnetic brush are selectively attracted to the latent image patterns present on exposure medium 18, developing those image patterns. As the exposed photoconductor passes the development station, toner is attracted to pixel locations of the photoconductor and as a result, a pattern of toner corresponding to the image to be printed appears on the photoconductor. As known in the art, conductive portions of development station 35, such as conductive applicator cylinders, are biased to act as electrodes. The electrodes are connected to a variable supply voltage, which is regulated by programmable controller 40 in response to LCU 24, by way of which the development process is controlled.

Development station 35 may contain a two component developer mix which comprises a dry mixture of toner and carrier particles. Typically the carrier preferably comprises high coercivity (hard magnetic) ferrite particles. As an example, the carrier particles have a volume-weighted diameter of approximately 30μ. The dry toner particles are substantially smaller, on the order of 6μ to 15μ in volume-weighted diameter. Development station 35 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to photoconductive exposure medium 18 to develop the electrostatic images thereon and the carrier material remains at development station 35. As toner is depleted from the development station due to the development of the electrostatic image, additional toner is periodically introduced by toner auger 42 into development station 35 to be mixed with the carrier particles to maintain a uniform amount of development mixture. This development mixture is controlled in accordance with various development control processes. Single component developer stations, as well as conventional liquid toner development stations, may also be used.

A transfer station 46 in printing machine 10 moves a receiver sheet S into engagement with photoconductive exposure medium 18, in registration with a developed image to transfer the developed image to receiver sheet S. Receiver sheets S may be plain or coated paper, plastic, or another medium capable of being handled by printer machine 10. Typically, transfer station 46 includes a charging device for electrostatically biasing movement of the toner particles from exposure medium 18 to receiver sheet S. In this example, the biasing device is roller 46b, which engages the back of sheet S and which is connected to programmable voltage controller 46a that operates in a constant current mode during transfer. Alternatively, an intermediate member may have the image transferred to it and the image may then be transferred to receiver sheet S. After transfer of the toner image to receiver sheet S, sheet S is detacked from exposure medium 18 and transported to fuser station 49 where the image is fixed onto sheet S, typically by the application of heat. Alternatively, the image may be fixed to sheet S at the time of transfer.

A cleaning station 48, such as a brush, blade, or web is also located behind transfer station 46, and removes residual toner from exposure medium 18. A pre-clean charger (not shown) may be located before or at cleaning station 48 to assist in this cleaning. After cleaning, this portion of exposure medium 18 is then ready for recharging and re-exposure. Of course, other portions of exposure medium 18 are simultaneously located at the various workstations of printing machine 10, so that the printing process is carried out in a substantially continuous manner.

LCU 24 provides overall control of the apparatus and its various subsystems as is well known. LCU 24 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to printing machine 10, or received from sources external to printing machine 10, such from as a human user or a network control. The output data and control signals from LCU 24 are applied directly or through storage latches to suitable output drivers and in turn to the appropriate subsystems within printing machine 10.

Process control strategies generally utilize various sensors to provide real-time closed-loop control of the electrostatographic process so that printing machine 10 generates “constant” image quality output, from the users perspective. Real-time process control is necessary in electrographic printing, to account for changes in the environmental ambient of the electrophotographic printer, and for changes in the operating conditions of the printer that occur over time during operation (rest/run effects). An important environmental condition parameter requiring process control is relative humidity, because changes in relative humidity affect the charge-to-mass ratio (q/m) of toner particles. The ratio q/m directly determines the density of toner that adheres to the photoconductor during development, and thus directly affects the density of the resulting image. System changes that can occur over time include changes due to aging of the printhead (exposure station), changes in the concentration of magnetic carrier particles in the toner as the toner is depleted through use, changes in the mechanical position of primary charger elements, aging of the photoconductor, variability in the manufacture of electrical components and of the photoconductor, change in conditions as the printer warms up after power-on, triboelectric charging of the toner, and other changes in electrographic process conditions. Because of these effects and the high resolution of modern electrographic printing, the process control techniques have become quite complex.

Process control sensor may be a densitometer 76, which monitors test patches that are exposed and developed in non-image areas of photoconductive exposure medium 18 under the control of LCU 24. Densitometer 76 measures the density of the test patches, which is compared to a target density. Densitometer may include an infrared or visible light led, which either shines through the exposure medium or is reflected by the exposure medium onto a photodiode in densitometer 76. These toned test patches are exposed to varying toner density levels, including full density and various intermediate densities, so that the actual density of toner in the patch can be compared with the desired density of toner as indicated by the various control voltages and signals. These densitometer measurements are used to control primary charging voltage Vo, maximum exposure light intensity Eo, and development station electrode bias Vb. In addition, the process control of a toner replenishment control signal value or a toner concentration setpoint value to maintain the charge-to-mass ratio q/m at a level that avoids dusting or hollow character formation due to low toner charge, and also avoids breakdown and transfer mottle due to high toner charge for improved accuracy in the process control of printing machine 10. The toned test patches are formed in the interframe area of exposure medium 18 so that the process control can be carried out in real time without reducing the printed output throughput. Another sensor useful for monitoring process parameters in printer machine 10 is electrometer probe 50, mounted downstream of the corona charging station 28 relative to direction P of the movement of exposure medium 18. An example of an electrometer is described in U.S. Pat. No. 5,956,544 incorporated herein by this reference.

Other approaches to electrographic printing process control may be utilized, such as those described in international publication number WO 02/10860 A1, and international publication number WO 02/14957 A1, both commonly assigned herewith and incorporated herein by this reference.

Referring to FIG. 2, image data to be printed is provided by an image data source 36, which is a device that can provide digital data defining a version of the image. Such types of devices are numerous and include computer or microcontroller, computer workstation, scanner, digital camera, etc. Multiple devices may be interconnected on a network. These image data sources are at the front end and generally include an application program that is used to create or find an image to output. The application program sends the image to a device driver, which serves as an interface between the client and the marking device. The device driver then encodes the image in a format that serves to describe what image is to be generated on a page. For instance, a suitable format is page description language (“PDL”). The device driver sends the encoded image to the marking device. This data represents the location, color, and intensity of each pixel that is exposed. Signals from data source 36, in combination with control signals from LCU 24 are provided to a raster image processor (RIP) 37 for rasterization.

In general, the major roles of the RIP 37 are to: receive job information from the server; parse the header from the print job and determine the printing and finishing requirements of the job; analyze the PDL (page description language) to reflect any job or page requirements that were not stated in the header; resolve any conflicts between the requirements of the job and the marking engine configuration (i.e., RIP time mismatch resolution); keep accounting record and error logs and provide this information to any subsystem, upon request; communicate image transfer requirements to the marking engine; translate the data from PDL (page description language) to raster for printing; and support diagnostics communication between user applications. The RIP accepts a print job in the form of a page description language (PDL) such as postscript, PDF or PCL and converts it into raster, or grid of lines or form that the marking engine can accept. The PDL file received at the RIP describes the layout of the document as it was created on the host computer used by the customer. This conversion process is also called rasterization as well as ripping. The RIP makes the decision on how to process the document based on what PDL the document is described in. It reaches this decision by looking at the beginning data of the document, or document header.

Raster image processing or ripping begins with a page description generated by the computer application used to produce the desired image. The raster image processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Halftone densities are formed by the application of a halftone “screen” to the byte map, especially in the case of image objects to be printed. Pre-press adjustments can include the selection of the particular halftone screens to be applied, for example to adjust the contrast of the resulting image.

Electrographic printers with gray scale printheads are also known, as described in international publication number WO 01/89194 A2, incorporated herein by this reference. The ripping algorithm groups adjacent pixels into sets of adjacent cells, each cell corresponding to a halftone dot of the image to be printed. The gray tones are printed by increasing the level of exposure of each pixel in the cell, by increasing the duration by way of which a corresponding light emitting diode (led) in the printhead is kept on, and by “growing” the exposure into adjacent pixels within the cell.

The above description applies to discharge area development (DAD) systems, but could apply equally as well to charged area development (CAD) systems as well.

The digital print system quantizes images both spatially and tonally. A two dimensional image is represented by an array of discrete picture elements or pixels, and the color of each pixel is in turn represented by a plurality of discrete tone or shade values (usually an integer between 0 and 255) which correspond to the color components of the pixel: either a set of red, green and blue (RGB) values, or a set of yellow, magenta, cyan, and black (YMCK) values that will be used to control the amount of ink, toner, or other marking material used by a printer.

Once the document has been ripped by one of the interpreters, the raster data goes to a page buffer memory (PBM) 38 or cache via a data bus. The PBM eventually sends the ripped print job information to the marking engine 10. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory. RIP 37, Memory Buffer 38, Render circuit 39 and Marking Engine 10 may all be provided in single mainframe 100, having a local user interfacel 10 (UI) for operating the system from close proximity.

As described hereinbefore, the RIP provides image data to a render circuit 39. The RIP 37, PBM 38 and render circuit 39 can be dedicated hardware, or a software routine such as a printer driver, or some combination of both, for accomplishing this task. The ripped data is provided to a writer driving controller.

Processes for developing electrostatic images using dry toner are well known in the art. The term “electrographic printer”, is intended to encompass electrophotographic printers and copiers that employ a photoconductor element, as well as ionographic printers and copiers that do not rely upon a photoconductor. Although described in relation to an electrographic printer, any printer suitable for digitally variable microprinting may be implemented in the practice of the invention.

Electrographic printers typically employ a developer having two or more components, consisting of resinous, pigmented toner particles, magnetic carrier particles and other components. The developer is moved into proximity with an electrostatic image carried on an electrographic imaging member, whereupon the toner component of the developer is transferred to the imaging member, prior to being transferred to a sheet of paper to create the final image. Developer is moved into proximity with the imaging member by an electrically-biased, conductive toning shell, often a roller that may be rotated co-currently with the imaging member, such that the opposing surfaces of the imaging member and toning shell travel in the same direction. Located adjacent the toning shell is a multipole magnetic core, having a plurality of magnets, that may be fixed relative to the toning shell or that may rotate, usually in the opposite direction of the toning shell. The developer is deposited on the toning shell and the toning shell rotates the developer into proximity with the imaging member, at a location where the imaging member and the toning shell are in closest proximity, referred to as the “toning nip”.

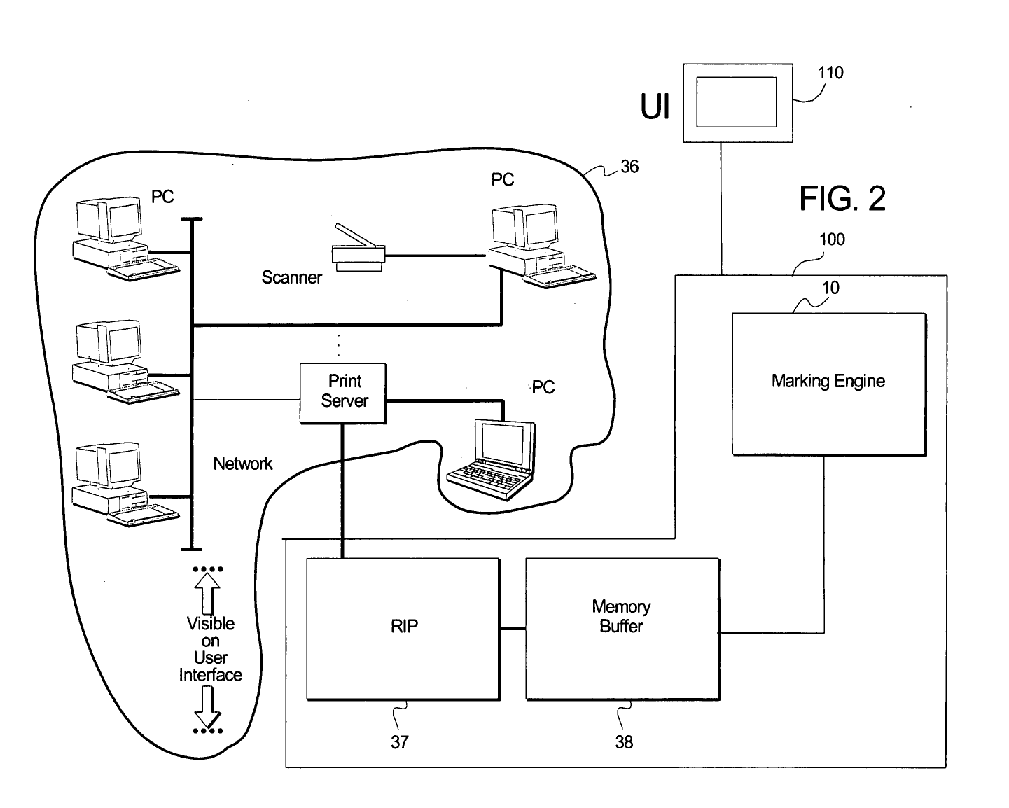

Referring now to FIG. 3, one embodiment of the development or toning stations 35, 35′ is presented. The development station 35 may comprise a magnetic brush 54 comprising a rotating shell 58, a mixture 56 of hard magnetic carriers and toner (also referred to herein as “developer”), and a rotating plurality of magnets 60 inside the rotating shell 58. The backup structure 35a of FIG. 1 is configured as a pair of backer bars 52. The magnetic brush 54 operates according to the principles described in U.S. Pat. Nos. 4,473,029 and 4,546,060, the contents of which are fully incorporated by reference as if set forth herein. The two-component dry developer composition of U.S. Pat. No. 4,546,060 comprises charged toner particles and oppositely charged, magnetic carrier particles, which (a) comprise a magnetic material exhibiting “hard” magnetic properties, as characterized by a coercivity of at least 300 gauss and (b) exhibit an induced magnetic moment of at least 20 EMU/gm when in an applied field of 1000 gauss, is disclosed. As described in the 060 patent, the developer is employed in combination with a magnetic applicator comprising a rotatable magnetic core and an outer, nonmagnetizable shell to develop electrostatic images. When hard magnetic carrier particles are employed, exposure to a succession of magnetic fields emanating from the rotating core applicator causes the particles to flip or turn to move into magnetic alignment in each new field. Each flip, moreover, as a consequence of both the magnetic moment of the particles and the coercivity of the magnetic material, is accompanied by a rapid circumferential step by each particle in a direction opposite the movement of the rotating core. The observed result is that the developers of the 060 flow smoothly and at a rapid rate around the shell while the core rotates in the opposite direction, thus rapidly delivering fresh toner to the photoconductor and facilitating high-volume copy and printer applications.

One toning station may be utilized for marking a first material, and the other toning station may be utilized for marking a second material. For example, station 35 may be utilized to print a hiding strip or area, and station 35′ may be utilized to print the machine readable image or characters. This arrangement could be reversed.

The electrostatic imaging member 18 of FIGS. 1 and 3 is configured as a sheet-like film. However, it may be configured in other ways, such as a drum, depending upon the particular application. A film electrostatic imaging member is relatively resilient, typically under tension, and the pair of backer bars 52 may be provided that hold the imaging member in a desired position relative to the shell 18.

According to a further aspect of the invention, the process comprises moving electrostatic imaging member 18 at a member velocity 64, and rotating the shell 58 with a shell surface velocity 66 adjacent the electrostatic imaging member 18 and co-directional with the member velocity 64. The shell 58 and magnetic poles 60 bring the mixture 56 of hard magnetic carriers and toner into contact with the electrostatic imaging member 18. The mixture 56 contacts that electrostatic imaging member 18 over a length indicated as L. The electrostatic imaging member is electrically grounded 62 and defines a ground plane. The surface of the electrostatic imaging member facing the shell 58 is a photoconductor that can be treated at this point in the process as an electrical insulator, the shell opposite that is grounded is an electrical conductor. Biasing the shell relative to the ground 62 with a voltage V creates an electric field that attracts toner particles to the electrostatic image with a uniform toner density, the electric field being a maximum where the shell 58 is adjacent to the electrostatic imaging member 18. Toning setpoints may be optimized, as disclosed in U.S. Pat. No. 6,526,247, the contents of which are hereby incorporated by reference as if fully set forth herein. The magnetic core may have 14 magnets, a maximum magnetic field strength of 950 gauss and a minimum magnetic field strength of 850 gauss. At 110 pages per minute the ribbon blender may rotate 355 RPM, the toning shell may rotate at 129.1 RPM, and the magnetic core may rotate at 1141 RPM. At 150 pages per minute the ribbon blender may rotate 484 RPM, the toning shell may rotate at 176 RPM, and the magnetic core may rotate at 1555.9 RPM.

The mass velocity (also referred to as bulk velocity) may have flow properties as described in the U.S. Patent Publication 2002/0168200 A1, the contents of which are incorporated by reference as if fully set forth herein. In one embodiment, the developer is caused to move through the image development area in the direction of imaging member travel at a developer mass velocity greater than about 37% of the imaging member velocity. In another embodiment, the developer mass velocity is greater than about 50% of the imaging member velocity. In a further embodiment, the developer mass velocity is greater than about 75% of the imaging member velocity. In a yet further embodiment, the developer mass velocity is greater than about 90% of the imaging member velocity. In a still further embodiment, the developer mass velocity is between 40% and 130% of the imaging member velocity, and preferably between 90% and 110% of the imaging member velocity. In another embodiment, the developer mass velocity is substantially equal to the imaging member velocity.

The toner particles may comprise MICR (Magnetic Ink Character Recognition) toner particles. A suitable MICR toner is described in U.S. Pat. No. 6,610,451 entitled, “DEVELOPMENT SYSTEMS FOR MAGNETIC TONERS HAVING REDUCED MAGNETIC LOADINGS”, with about 23% iron oxide and 8% olefinic wax by weight, and a silica surface treatment. The U.S. Pat. No. 6,610,451 patent is incorporated by reference as if fully set forth herein. A polymethylmethacrylate surface treatment may also be implemented, for example catalogue number MP1201 available from Soken Chemical & Engineering Co., Ltd., Tokyo, Japan, and distributed by Esprix Technologies of Sarasota, Fla. The carrier particles may be SrFe12O19 coated with polymethylmethacrylate. Volume mean diameter of 20.5 microns (sigma=0.7 microns for ten production runs of a carrier material), measured using an Aerosizer particle sizing apparatus (TSI Incorporated of Shoreview, Minn.). A suitable carrier has a coercivity of 2050 Gauss, a saturation magnetization of 55 emu/g, and a remnance of 32 emu/g, measured using an 8 kG loop on a Lake Shore Vibrating Sample Magnetometer (Lake Shore Cryotronics, Inc., of Westerville, Ohio). The invention is not limited to MICR toner.

Other toners are also suitable in the practice of the invention. Polyester based toners and styrene acrylate polymer based toners, for example, without limitation, as described in published U.S. Patent Applications 2003/0073017, 2003/0013032, 2003/0027068, 2003/0049552, and unpublished U.S. patent application Ser. Nos. 10/460,528—filed Jun. 12, 2003—“Electrophotographic Toner and Developer with Humidity Stability”, and Ser. No. 10/460,514—filed Jun. 12, 2003—“Electrophotographic Toner with Uniformly Dispersed Wax” may be implemented.

It should be understood that colored toners, created from any polymer suitable for use in printers as described above, commonly called “accent colors”, or even those suitable for “process colors”, may be utilized in the practice of this invention as well. The term “accent colors” is used here to indicate colored toners (other than black) generally used by themselves to print their own color, while “process colors” refers to colored toners (other than black) generally used in combination to create the visual impression of a color frequently different from any of the original colors. Process colored toners can obviously be used as a single toner in the same manner as accent colored toners. Furthermore, this invention contemplates the use of clear or colored toners containing dyes sensitive to ultraviolet or infrared radiation and producing fluorescence when exposed to those radiations.

Magnetic Ink Character Recognition (MICR) technologies have been used for many years for the automated reading and sorting of checks and negotiable payment instruments, as well as for other documents in need of high speed reading and sorting. As well known in the art, MICR documents are printed with characters in a special font (e.g., the E13-B MICR font in the United States, and the CMC-7 MICR standard in some other countries). Typically, MICR characters are used to indicate the payor financial institution, payor account number, and instrument number, on the payment instrument. In addition to the special font, MICR characters are printed with special inks or toners that include magnetizable substances, such as iron oxide, that can be magnetized in the reading process. The magnetized MICR characters present a magnetic signal of adequate readable strength to the reading and sorting equipment, to facilitate automated routing and clearing functions in the presentation and payment of these instruments.

The relatively heavy loading of iron oxide in conventional MICR toner for electrographic MICR printing has been observed to adversely affect the image quality of the printed characters, however. It is difficult to achieve and maintain an adequate dispersion of the heavy iron oxide particles in the toner resin. In addition, the toning and fusing efficiencies of MICR toners are poorer than normal (i.e., non-MICR) toners, because of the magnetic loadings present in the MICR toner. Accordingly, the image quality provided by MICR toner is often poorer than those formed by normal toner, unless the printing machine makes significant adjustments in its printing process.

Many documents having MICR characters also include printed features and characters that are not MICR characters. This of course requires either two printing passes (one pass for MICR printing using MICR toners and another pass for the non-MICR printing using normal toners), or the printing of both the MICR and non-MICR features with MICR toners. In some installations, the MICR printing volume is sufficient that one electrographic printer is dedicated to the printing of the MICR characters on all documents, with other printers used to print the non-MICR features on those documents. In other installations, the MICR encoded volume is less than the capacity of one printer. Some conventional electrographic printing systems permit the swapping of toning stations, so that the operator can switch between MICR and normal toners, for printing MICR and non-MICR documents, respectively.

As noted above, MICR characters are used for the printing of sensitive information such as financial institution routing numbers, and account numbers. Unauthorized use of these numbers on payment documents can facilitate fraud and theft. As such, MICR printing is preferably carried out in reasonably secure environments, by trusted human operators.

It has been observed, in connection with this invention, that the differences between MICR toners and normal toners, particularly in the developing or toning process of electrographic printing, require different operational settings for optimal image formation using MICR toners from the operational settings for optimal image formation using normal toners. Accordingly, the operator ought to change the operational settings of the electrographic printer as he or she swaps toning stations to change between MICR and normal toners.

According to this embodiment of the invention, toning station 38a contains Magnetic Ink Character Recognition (MICR) toner, as used for the printing of MICR encoded characters, such as bank routing numbers and account numbers on checks. Other documents that are commonly printed with at least some MICR encoded characters include airline tickets, vouchers, return receipts, and the like. Toning station 38b (available but not installed in the configuration shown in FIG. 1) contains conventional toner, and is for conventional black-and-white printing by electrographic printer 10. In general, the toner in each of the multiple toning stations 38a, 38b consists of a two component developer mix which comprises a dry mixture of toner and carrier particles. The carrier particles are typically high coercivity (hard magnetic) ferrite particles, which are generally quite large (e.g., on the order of 30μ in volume-weighted diameter), while the dry toner particles are substantially smaller (e.g., on the order of 6μ to 15μ in volume-weighted diameter). The specific composition of the developer mix will depend upon the desired characteristics for the particular printing job, as will be described in further detail below.

MICR toner, as contained in toning station 38a, conventionally includes a heavy loading of iron oxide or another magnetic material, in its toner particles. When printed on a document, preferably in a MICR font, this magnetic material provides a sufficiently strong magnetic signal to a conventional MICR reader that the characters printed using the MICR toner can be magnetically read. In addition, as well known in the art, conventional MICR toner also contains a sufficient amount of carbon black or another dye as to be visible when printed on conventional paper or other media; in addition, the MICR font also resembles the alphanumeric characters sufficiently that MICR encoded text is human-readable. A composition of a MICR toner is described in U.S. Pat. No. 6,610,451 issued Aug. 26, 2003, commonly assigned herewith and incorporated herein by this reference.

Conventional toner as contained in toning station, may be of a conventional type of toner or developer mixture as appropriate for non-coded printing, depending upon the particular printing task that is to be carried out with the toning station installed in print engine. The dye contained within this conventional toner will, of course, correspond to the desired color of printed output.

Certain process control parameters have been observed, in connection with this invention, to be dependent upon the type of toner used. More specifically, it has been observed that MICR toners and conventional normal toners require different process control parameter setpoints for optimal printing. One such setting is the adjustment of primary charging voltage and exposure according to the aim densitometer 76 output voltage, which preferably differs between MICR and other toners. In addition, the fusing temperature applied by fuser station 49 is preferably set to different temperatures for MICR toners (e.g., on the order of 190° C.) than for normal toners (e.g., on the order of 180° C.). Other process parameters that preferably differ for MICR and normal toners include fuser heater cleaning web advance rate, the transfer current applied by transfer station 46, and the toning station bias voltage Vb applied by variable power supply 19 under the control of programmable controller 40. It is contemplated that those skilled in the art having reference to this specification will recognize other process parameters that have different optimal settings for use in connection with different types of toners, including MICR toners.

As mentioned above, MICR encoded characters are often used for financial instruments, or for documents that are associated with significant monetary value (e.g., airline tickets, vouchers, etc.). The financial value of these types of documents often make it prudent to incorporate security functions for the printing of MICR encoded documents. These security functions of course are often not necessary for documents that are not MICR encoded, or for the printing of the non-MICR encoded portions of documents that will eventually be MICR encoded.

Printing machine 10 may have two available toning stations (35, 35′), with one toning station associated with MICR toner. It is of course contemplated that more than two toning stations may be available, each with their own associated optimal printing and process conditions; it is further contemplated that these toning stations 38 may not necessarily include a toning station having MICR toner. This description is based on toning station having such MICR toner, however, because it is contemplated that this invention is particularly advantageous when applied to MICR encoded printing.

There are two aspects of MICR toner printing which are used either together or separately to create the effects described below. Together they combine to make a security feature of broad useability. The first aspect is that a toner deposit is raised above the substrate on which it is printed, i.e. has surface relief. This relief can be felt with the fingertips or viewed as the substrate is tilted toward a specular source of light. Secondly, the MICR toner deposit can be read magnetically, either as a defined font (CMC-7 or E13b) or as a pulse on a magnetic reader.

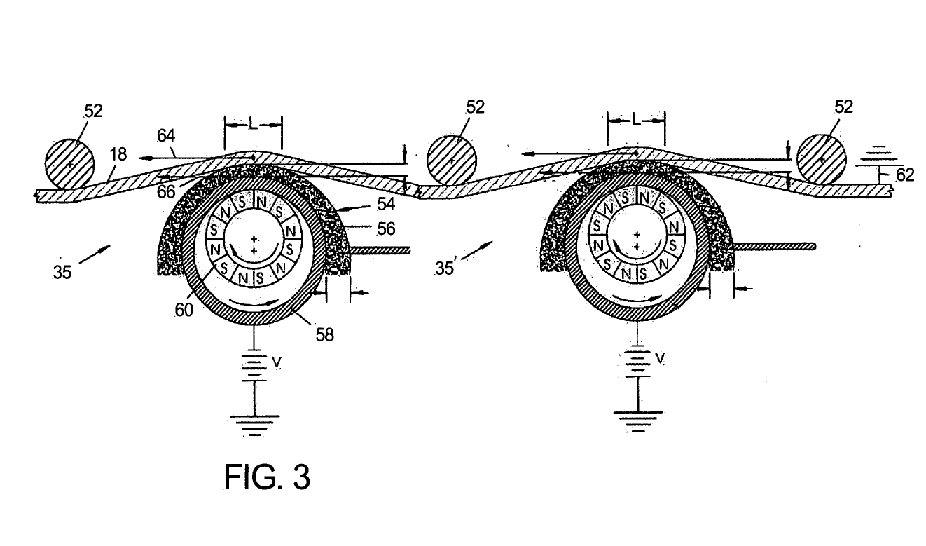

FIG. 4 illustrates an exemplary hiding strip 202 which would be printed on a receiver, such as a check, bill, or other instrument. The strip 202 may be any of number of shapes, sizes, colors, marking materials and marking material thickness.

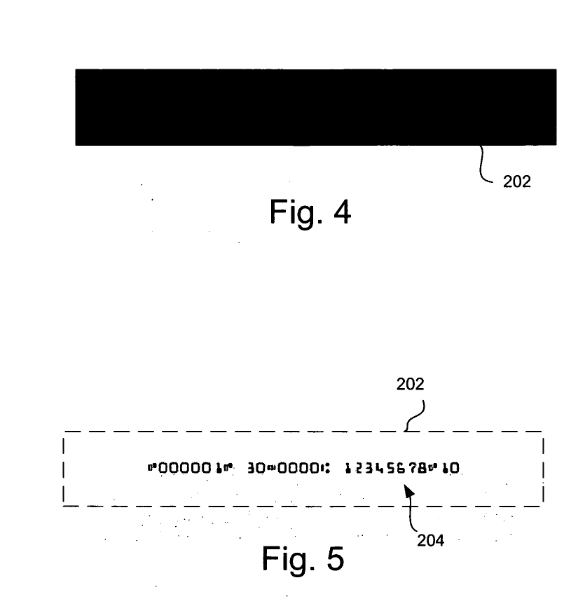

FIG. 5 illustrates the hiding strip 202 in outline. Either beneath or on top of strip 202 is printed or marked a security image 204 or characters which is/are intended to remain “hidden” from visual detection or reading by people but readable by a machine or apparatus. For example, the characters might comprise a code line of MICR characters or bars, etc. In order to accomplish this, the strip 202 and characters 204 are preferably the same color marking material. For instance, if both are black, it is difficult or impossible to read the characters 204 because they blend together visually. The characters 204 however, are comprised of a marking material which can be read by machine. For instance, they may be comprised of MICR material. If the characters are printed first, then the overlaying hiding strip 202 must be of appropriate thickness such that the underlying characters 204 can still be read by machine. If characters 204 are printed first, then toning station 35 in FIG. 3 would be the toning station with the character marking material and station 35′ would be the station with the overlaying material. The stations would be switched if the characters 204 would be overlaying strip 202. Other marking materials which may be used for characters 204 include ultraviolet or infrared readable materials, for instance.

The word overlay as subsequentially used should be taken to include lamination with another material, printed with ink jet or toner materials or other printing techniques.

An overlay of a laminate or low density nonmagnetic printing would allow the MICR pattern to be read using conventional magnetic readers if in a defined font or could be read as a pattern with magnetic properties.

A simple MICR code line could be hidden by an overlay of non-magnetic printing of which the MICR toner makes up part of the pattern but is not otherwise distinguished. This would disguise the code visually but still allow it to be read magnetically.

On the other hand, if a MICR toner pattern is covered by a thin opaque film as a lamination or as an opaque printed layer of non-magnetic material, then the MICR pattern would not be readily seen, i.e. it would be covert, and yet readable using specular illumination because of its inherent surface relief or a magnetic reader because of its magnetic properties. The opaque overlay could be printed with or used for any other security or explanatory feature as desired, e.g. a holographic state seal.

This presents a number of security features. For example, it protects the toner image from tampering by placing it beneath a protective layer. Second, the opaque overlay prevents the content from being easily read, requiring special circumstances for reading but allowing its presence to be detected by an intended reader.

A simple one-dimensional barcode would be easily readable by a waveform magnetic reader as a string of pulses and decoded by a computer algorithm in the manner that barcodes are decoded normally. While readability by a human is limited for a barcode just as it is with high contrast printed barcodes, decoding the magnetic signal would be straightforward. That a code is present would be easily detected by a cashier or ticket-taker and its presence may be enough to gain entrance to a concert, for example. With a specular lamination or printed overlayer, a laser barcode reader should be able to read the reflected pattern as well. With a printed overlay, a second overt and possibly different barcode could be printed or other information could be presented.

Because of the distance-sensitive nature of magnetic read heads, any lamination should be thin, on the order of less that about 0.002-inches. A thin shiny tape surface allows the toner deposit relief to be seen using a specular light source.

For example, a 0.0025-inch thick tape overlay has reduced the signal seen by a RDM MICR Qualifier by approximately 50%, to 53% through 59% of original average relative magnetic signal strength using three different tapes. The MICR characters were completely readable but of low signal strength. In addition, the shape of the character is recognizable under proper lighting, e.g. specular light and presumably laser light. In testing of three different tapes, the magnetic waveform maintained its shape with respect to character size and magnetic peak placement. Paints, inks, or other types of opaque coatings are expected to perform in the same manner since the decrease in magnetic signal strength appears to be a function of distance between magnetic deposit and magnetic reader.

The exemplary patterns illustrated in FIG. 5 may be composed of one and two pixel objects or lines. The density of these objects or lines may be controlled relative to other pixels according to the principles of U.S. patent application Ser. No. 10/812,463 entitled, “POST RIP IMAGE RENDERING FOR MICROPRINTING”, filed Dec. 3, 2003, naming Gregory G. Rombola, Thomas J. Foster, and John F. Crichton as inventors, the contents of which are incorporated by reference as if fully set forth herein. With a writer having grey-level functionality, the density of marking medium applied to an area on the receiver corresponding to a pixel may be controlled. For example, if eight bits per pixel are provided, 0 may correspond to no marking, and 255 may correspond to a maximum marking density. Any marking density within the range of 0-255 may be applied to the one pixel objects or lines, the two pixel objects or lines, or both. The density of the remaining pixels comprising a printed image may be maintained at another exposure level, 255 for example. In such manner, the legibility of microprinted alphanumeric characters or the printing of a pantograph may be optimized, generally through an iterative interactive process of making adjustments and printing the results. The density level may be changed interactively using an appropriate software interface, as shown FIG. 9 of the POST RIP IMAGE RENDERING IN AN ELECTROGRAPHIC PRINTER FOR MICROPRINTING patent application (in particular, the “One Pixel Wide” and “Two Pixel Wide” adjustments). With an electrographic imaging member, toning density is varied by varying exposure of the member.

Security of documents may be enhanced with microprinted lines incorporating information specific to the document, for example a negotiable instrument, such as payees name and amount or encrypted cypher code. A check with a border, boxes, lines, etc. that are actually the payee and amount and/or other variable information associated with the document printed in microprinting would create a huge hurdle for a fraudster who wished to alter the check and have it go undetected.

In addition to being document specific, the microprinted line would be removed with the same difficulty as other information on the document. A digitally applied signature extending over the microprinted signature line would then be very difficult to remove without disturbing the line.

While use of MICR toner makes possible microprinting in addition to the MICR line itself in a single pass through the machine, nonMICR toner should work as well for the microprint line or box itself.

A digitally applied microprinted line of MICR toner can also be sensed magnetically. While it cannot be magnetically read as digits without being printed in an E13b or CMC-7 font, the fact that the material making up the line is magnetically active is easily shown with a standard magnetic check reader.

Digitally applied microprinting has the security characteristics of lithographically printed lines, i.e. not copyable, not overtly visible, easily read using low power magnification. In addition to those characteristics, microprinting using a Digimaster 9110m printer, manufactured by Heidelberg Digital L.L.C. of Rochester, N.Y., is digitally variable, similar in removal resistance to other elements, and applied in the same machine printing pass as the other variable data on the document.

The present invention may be used in any type of digital printing system, such as electrostatographic, electrophotographic, inkjet, laser jet, etc. of any size or capacity in which pixel exposure adjustment value is selected prior to printing.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

### PARTS LIST

10 printer machine
18 exposure medium
18a surface
19 variable power supply
20 motor
21a-21g rollers or other supports
24 logic and control unit
28 charging station
30 voltage controller
32 interface controller
34 exposure station
34a writer
35 development station
35′ station
35a backup roller
36 image data source
37 raster image processor
38 page memory buffer
38a multiple toning station
38b multiple toning station
39 image render circuit
40 programmable controller
42 toner auger
46 transfer station
46a programmable voltage controller
46b roller
48 cleaning station
49 fuser station
50 electrometer probe
52 backer bars
54 magnetic brush
56 mixture
58 rotating shell
60 magnetic poles
62 ground
64 member velocity
66 surface velocity
76 densitometer
100 mainframe
110 local user interface
202 hiding strip
204 security image
L length
P arrow
S receiver sheet
V voltage
Vb bias voltage

What is claimed is:

1. A printing method, comprising:
marking an area of a receiver with a first marking material; and,
marking in at least a portion of the area a security image with a second marking material, wherein the first and second marking material are configured such that the security image is unreadable by human vision and readable by a method other than human vision.

2. The method of claim 1, wherein the second marking material is MICR material.

3. The method of claim 1, the second marking comprising marking with accent color material.

4. The method of claim 1, the second marking comprising marking with clear material.

5. The method of claim 1, the second marking comprising marking with color material other than black.

6. The method of claim 1, the second marking comprising marking with material that is sensitive to ultraviolet radiation.

7. The method of claim 1, the second marking comprising marking with material that is sensitive to infrared radiation.

8. The method of claim 1, wherein the first marking material comprises at least one of the following: toner; ink; and tape.

9. The method of claim 1, wherein the second marking material comprises at least one of the following: toner; and ink.

10. A printer for printing on an area of a receiver with a first marking material, the printer comprising:
a print engine for marking the receiver with a second marking material;
a controller for controlling the print engine to print a security image in at least a portion; and
marking in at least a portion of the area a security image with a second marking material, wherein the first and second marking material are configured such that the security image is unreadable by human vision and readable by a method other than human vision.

11. The printer of claim 10, wherein the second marking material is MICR material.

12. The printer of claim 10, the second marking comprising marking with accent color material.

13. The printer of claim 10, the second marking comprising marking with clear material.

14. The printer of claim 10, the second marking comprising marking with color material other than black.

15. The printer of claim 10, the second marking comprising marking with material that is sensitive to ultraviolet radiation.

16. The printer of claim 10, the second marking comprising marking with material that is sensitive to infrared radiation.

17. The printer of claim 10, wherein the first marking material comprises at least one of the following: toner; ink; and tape.

18. The printer of claim 10, wherein the second marking material comprises at least one of the following: toner; and ink.
